(19) United States
(12) Patent Application Publication
(10) Pub. No.: US 2006/0274352 A1
(43) Pub. Date: Dec. 7, 2006

(54) Copying machine, server device, shredder apparatus, information terminal, and copy control method

(76) Inventors: Kyoichi Nakaguma, Yokohama (JP); Hideo Ito, Yokohama (JP); Hideki Nakamura, Inzei (JP); Shigeki Hataya, Otaru (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,417

(22) Filed: Mar. 6, 2006

(30) Foreign Application Priority Data
Jun. 7, 2005 (JP) 2005-166326

(51) Int. Cl. G06K 15/00

(52) U.S. Cl. 358/1.14; 358/1.15

(57) ABSTRACT

A device and a method using an RFID on a stapler needle or a holder provide mechanisms of: relating RFID information and printed information automatically, when a paper document is printed or copied; prohibiting to copy a secret or an expired document; and detecting a paper document bound by a stapler needle with an RFID. Control information is created and identifier 101 of an RFID is changed, and a stapler needle is attached to a printed paper document. To copy a paper document, an identifier of the RFID is obtained to control printing by determining whether or not the document is a secret document or an expired document. An information terminal receives an identifier of an RFID to compare with control information and notifies a detection of a target document.

### INCORPORATION BY REFERENCE

This application claims priority from Japanese Patent Application No. JP2005-166326, filed on Jun. 7, 2005, the content of which is hereby incorporated by reference into the application.

### BACKGROUND OF THE INVENTION

The present invention relates to a system for achieving document control or management, and in particular, to a copying machine communicating with a Radio-Frequency Identifier (RFID), a server device keeping image information, a shredding apparatus, an information terminal, and a copy control method for a copying machine.

Recent information-based business in offices has been advanced due to development of technologies and techniques associated with Office Automation (OA), networks, and internet. This results in a steady increase in the amount of information items handled by such advanced business. The office automation in the information-based society makes it possible to control such a large amount of information items using a server device. Each user can obtain desired and required information according to necessity by using a terminal such as a personal computer to process and to use the information at a high speed.

However, the information items are more often used in the form of printed or copied matter than in the form of electronic documents. Specifically, an electronic document stored in a server is printed on a sheet of paper by a printer or is copied onto a sheet of paper by a copying machine. That is, the information is moved onto a sheet of paper as a recording medium. Particularly, when information printed in the form of, for example, documents for a conference is quite valuable as assets and is simultaneously also secret information, there arises a considerable problem of protection of the information.

JP-A-2005-71294 describes a technique for a method of managing such information on the paper. That is, by reading information of an RFID mounted on a sheet of paper on which the information is placed, it is possible to identify each sheet of paper. For a document printed on sheets of paper, the technique makes it possible to obtain the contents of the document for each sheet of paper.

### SUMMARY OF THE INVENTION

In the conventional techniques, it is troublesome to collate the information of the RFID with the printed document. There does not exists any mechanism to discard information of which a period of validity has passed. Moreover, the techniques of the prior art does not include any mechanism to restrict copying of secret information. To find out a required document of paper from a large amount of documents of paper, there exists only a method to visually check the contents of paper documents by turning over each sheet of paper. That is, even if secret information not to be read or accessed by a third party exists in a large amount of sheets of paper, it is not possible to detect the secret information.

It is therefore an object of the present invention to provide, for a stapler needle or a holder on which an RFID is mounted, a mechanism to automatically relate, when a document of paper is printed or copied by a copying machine, information of an RFID to information thus printed; a mechanism to inhibit, when a document to be copied is a secret document or is a document of which a period of validity is overdue, the copy of the document; a mechanism to implement a shredding function of making a check, for a document to be shredded, to determine that a period of validity of the has passed; a mechanism to easily find out a document of sheets of paper bound by stapler needles with an RFID installed therein; and a mechanism to change, when a secret document is detected, notifying representation thereof.

The present invention achieves the object as described below.

That is, the stapler needle of the present invention includes a communication unit to communicate with a copying machine, which is described later, or with a server device and a shredder apparatus connected to or incorporated in a copying machine and an identifier to identify an RFID.

The copying machine, the server device, or the shredder apparatus of the present invention includes part of or all of an image obtaining unit to obtain an image of a paper document, an image information creating unit to create image information from the image, a printing unit to print the image information, a control unit to control the printing unit, an encrypting unit to encrypt the image information, a file creating and deleting unit to create and to delete an image file of the image information, an input and output unit to receive an input from the user and to display information, a control information creating and deleting unit to create and to delete control information corresponding to the image file thus created to thereby control a control information table, an RFID communicating unit to communicate with a communicating unit of the RFID of the stapler needle to receive or to transmit an identifier, an identifier writing unit to rewrite an identifier of the stapler needle using an identifier in the control information by the RFID tag communicating unit, a stapler attaching unit to attach the stapler needle to paper, an identifier obtaining unit to obtain an identifier of the stapler needle using the RFID communicating unit, a secret presence or absence determining unit to check the identifier and the control information to determine whether or not target information is secret information, a validation period determining unit to check the identifier and the control information to determine whether or not a validation period of the target information has passed, a deletion determining unit to check the identifier and the control information to determine whether or not the target information is deletable, a stapler needle position acquiring unit to measure a position of the stapler needle using the RFID communicating unit, a paper document discarding unit to discard the paper document by a shredding apparatus, and a stamp detecting unit to check presence or absence of an icon or an image indicating that target information is secret information.

According to the present invention, the information terminal includes part or all of an RFID communicating unit to communicate with the RFID of the stapler needle, a distance measuring unit to measure distance to the stapler needle, an input unit to receive an input from a user, a measurement distance changing unit to change sensitivity of the RFID communicating unit according to distance designation of the user input to change the measurement distance, an identifier acquiring unit to acquire the identifier from the stapler needle using the RFID communicating unit, a control information retrieval unit to obtain the control information through communication with the copying machine-server device-shredder apparatus to retrieve control information corresponding to an input from the user, an identifier matching determining unit to check the control information to determine whether or not the control information matches the identifier obtained by the identifier acquiring unit, a notifying unit to notify, if the control information matches the identifier, the matching event, a light emission unit to send notification to the user by light from a light emitting device, a sounding unit to send notification to the user by voice, sound, or vibration using a sounding device, a secret presence or absence determining unit to check the identifier obtained by the identifier obtaining unit and the control information to determine whether or not target information is secret information, a notification suppression emphasizing unit having a function which changes, if the information is secret information, a notifying method of the notifying unit, an image file acquiring unit to acquire, according to the control information retrieved by the control information retrieval unit, an image file from the file creating and deleting unit of the copying machine-server device-shredder apparatus, a decrypting unit to decrypt, if the image file has been encrypted, the image file, and a display unit to display an image file using a display of the information terminal.

The objects of the present invention including a mechanism to automatically relate, when a document of paper is printed or copied by a copying machine, information of an RFID to information thus printed; a mechanism to inhibit, when a document to be copied is a secret document or is a document of which a period of validity is overdue, the copy of the document; and a mechanism to implement a shredding function of making a check, for a document to be shredded, to determine that a period of validity of the document has passed are achieved by operations of the units as below.

An image obtaining unit obtains an image of a paper document and an image information creating unit creates image information from the image. A printing unit prints the image information onto paper to produce a copy of a paper document. A control unit controls operation of the printing unit. An encrypting unit encrypts the image information, a file creating and deleting unit creates and saves an image file of the image information. A control information creating and deleting unit creates or deletes control information corresponding to the image file. An RFID communicating unit communicates with the RFID of the stapler needle attached to the paper document and an identifier obtaining unit obtains an identifier of the RFID. A control information creating and deleting unit registers the identifier to the control information. If it is not possible for the RFID communicating unit to communicate with the RFID, the control information creating and deleting unit assumes new registration and then creates a new identifier to register the identifier to the control information. An identifier writing unit writes the identifier as an identifier of the stapler needle using the RFID communicating unit. A stapler attaching unit attaches the stapler needle to the paper document printed by the printing unit. As a result, when a document of paper is printed or copied by the copying machine, information of an RFID can be automatically related to information thus printed.

Additionally, a secret presence or absence determining unit checks the identifier and the control information to determine whether or not target information is secret information. If it is determined that the target information is secret information, the control unit inhibits a printing operation of the image information by the printing unit. A stapler detecting unit determines whether or not the image file includes an icon or an image indicating that target information is secret information. If it is determined that the target information is secret information, the control unit inhibits a printing operation of the image information by the printing unit. A validation period determining unit checks the identifier and the control information obtained from the stapler needle to determine whether or not a validation period of the target information has passed. If it is determined that the validation period of the target information has passed, the control unit inhibits a printing operation of the image information by the printing unit and simultaneously discards the paper document inserted in a shredder apparatus by shredding the document by a paper document discarding unit.

The remaining objects of the present invention including a mechanism to easily find out a paper document bound by a stapler needle with an RFID installed therein and a mechanism to change, when a secret document is detected, notifying representation thereof are achieved by operations of the units as below.

An RFID communicating unit communicates with the RFID of the stapler needle and an identifier obtaining unit obtains an identifier of the RFID. In this situation, a distance measuring unit measures distance between the stapler needle and an information terminal, an input unit receives detection sensitivity or measurement distance from a user, and a measurement distance changing unit changes sensitivity or measurement distance of the RFID communicating unit according to the detection sensitivity or the measurement distance from a user. A control information retrieval unit makes a retrieval to obtain the control information from a control information creating and deleting unit of the copying machine-server device-shredder apparatus on the basis of a condition inputted from the input unit by the user. An identifier matching determining unit compares the control information with the identifier to determine whether or not the control information matches the identifier. A notifying unit notifies, if it is determined that the control information matches the identifier, the matching event to the user. A light emission unit sends notification to the user by light from a light emitting device and a sounding unit sends notification to the user by voice, sound, or vibration using a sounding device. An image file acquiring unit acquires, according to the control information, an image file from the file creating and deleting unit of the copying machine-server device-shredder apparatus. A decrypting unit decrypts, if the image file has been encrypted, the image file to convert the file into a displayable image format. A display unit displays an image file, namely, displays on a display of the information terminal an image of a file corresponding to information indicated by the user. A secret presence or absence determining unit checks the identifier and the control information to determine whether or not target information is secret information, and a notification suppression emphasizing unit changes, if the information is secret information, notifying representation of the notifying unit.

According to the present invention, it is possible in a system including a copying machine-server device-shredder apparatus and a stapler needle with an RFID to implement a mechanism to automatically relate, when a document of paper is printed or copied by a copying machine, information of an RFID to information thus printed and a mechanism to inhibit, when a document to be copied is a secret document or is a document of which a period of validity is overdue, the copy of the document. Also, it is possible to implement a mechanism to implement a shredding function of making a check, for a document to be shredded, to determine that a period of validity of the has passed. The present invention further makes it possible to implement a mechanism to easily find out a document of sheets of paper bound by stapler needles with an RFID installed therein and a mechanism to change, when a secret document is detected, notifying representation thereof.

According to the present invention, it is possible in operation to print and to copy a paper document by a copying machine to implement a mechanism to inhibit, when a document to be copied is a secret document or is a document of which a period of validity is overdue, the copy of the document and a mechanism to easily find out a paper document bound by a stapler needle with an RFID installed therein.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a copying machine-server device-shredder apparatus.

FIG. 2 is a block module of an information terminal.

FIG. 3 is an explanatory diagram of a control information table and control information.

FIG. 4 is an explanatory diagram of document property.

FIG. 5 is a flowchart of system operation.

FIG. 6 is a flowchart of processing to create control information.

FIG. 7 is a flowchart of operation of a shredder function to shred a document.

FIG. 8 is a flowchart of operation of an information terminal to make a search for a document.

### DESCRIPTION OF THE INVENTION

Referring now to the drawings, description will be given of an embodiment of the present invention.

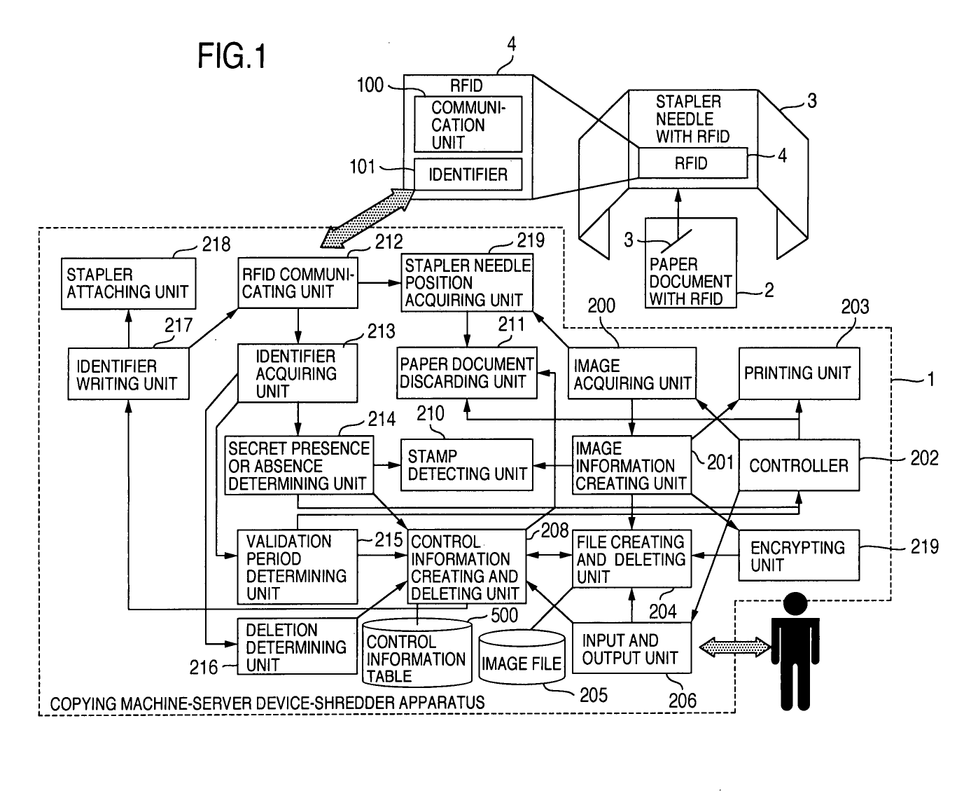

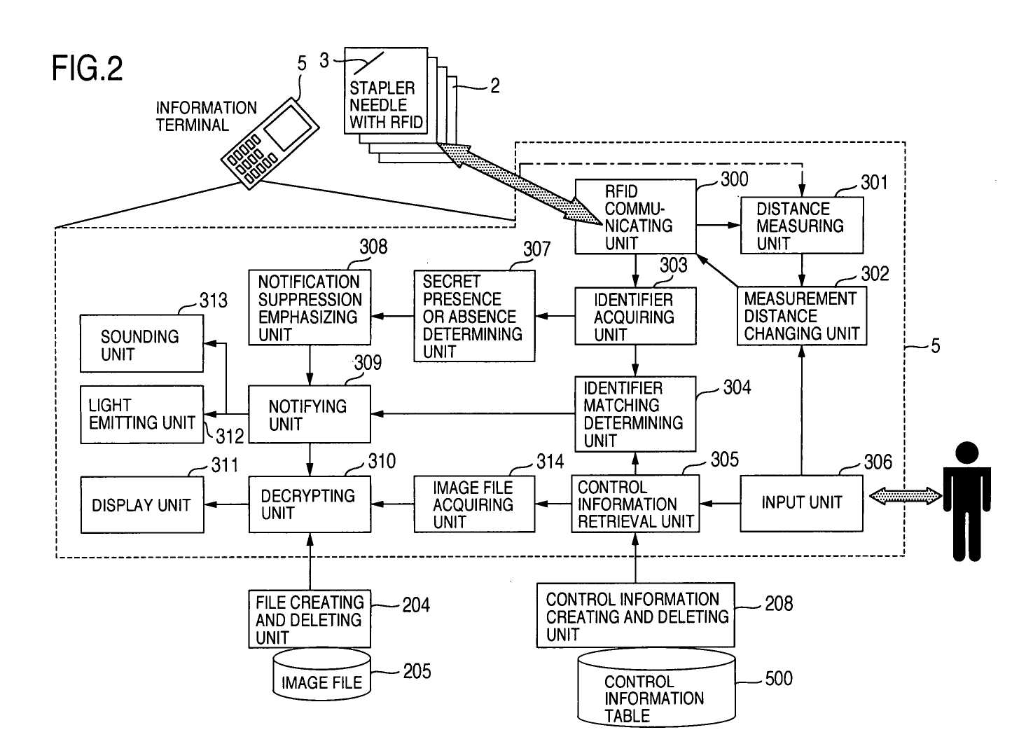

FIGS. 1 and 2 show an example of a block diagram showing a configuration of an embodiment of a document management system according to the present invention. The document management system includes a wireless RFID paper document 2, a copying machine-server device-shredder apparatus 1, and an information terminal 5. The document 2 includes sheets of paper of a document bound by a stapler needle 3 with RFID. The needle 3 keeps an RFID 4. The RFID 4 includes a communication unit 100 and an identifier 101 to identify the stapler needle 3. Although the needle 3 is an almost U-shaped needle employed in a stapler, there may also be used, as the needle 3, any item of stationery which binds sheets of paper and which are freely attachable and detachable by a user. For example, there may be used a document holder, a clip, a binding string, a binding item called “Gachadama” in Japanese, or a tape. In short, there may be used a binding item with RFID which binds sheets of paper such that the binding item can be integrally controlled or managed together with the sheet of paper.

Referring to FIG. 1, description will be given of an embodiment of a copying machine-server device-shredder apparatus 1. The constituent components of the system 1 may be separately arranged or constructed as one unit. That is, the server device may be separated from the copying machine to be connected via a network thereto. Or, the copying machine may include a server function. Also, the shredder apparatus unit may be separated from the copying machine or may be configured in a unit together with the copying machine. Additionally, the copying machine may include a stapler attaching unit or may be separated therefrom.

The copying machine-server device-shredder module 1, i.e., the system 1 includes an image acquiring unit 200 to acquire an image of a paper document, an image information creating unit 201 to create image information from an image, a printing unit 202 to print the image information, an encrypting unit 219 to encrypt image information, a file creating and deleting unit 204 to create or to delete an image file 205 of the image information, an input and output unit 206 to receive an input from a user or to display information, a control information creating and deleting unit 208 to create or to delete control information 510 corresponding to the created image file 205 to thereby control the information using a control information table 500, an RFID communicating unit 212 to receive or to transmit an identifier 101, an identifier writing unit 217 to write an identifier 530 contained in the control information 510 in an identifier 101 of the stapler needle 3 using the RFID communicating unit 212, a stapler attaching unit 218 to attach the stapler needle 3 onto the paper document 2, and an identifier acquiring unit 213 to acquire the identifier 101 of the stapler needle 3 using the RFID communicating unit 212. The system 1 further includes a secret presence or absence determining unit 214 to check the identifier 101 and the control information 510 to determine whether or not the information under consideration is secret information, a validation period determining unit 215 to check the identifier 101 and the control information 510 to determine whether or not a validation period of the information under consideration has passed, a deletion determining unit 216 to check the identifier 101 and the control information 510 to determine whether or not the information under consideration is deletable, a stapler needle position acquiring unit 219 to measure a position of the stapler needle 3 using the RFID communicating unit 212, a paper document discarding unit 211 to discard the paper document 2 by the shredder apparatus, and a stamp detecting unit 210 which retrieves image information created by the image information creating unit 201 to make a check to determine presence or absence of an icon or an image indicating that the pertinent document is a secret document.

Referring now to FIG. 2, description will be given of the information terminal 5 according to the embodiment.

The information terminal 5 of the embodiment includes an RFID communicating unit 300 to communicate with the RFID 4 of the stapler needle 3, a distance measuring unit 301 to measure distance to the stapler needle 3, an input unit 306 to receive an input from a user, a measurement distance changing unit 302 to change sensitivity of the RFID communicating unit 300 according to distance designation of the user input to change the measurement distance, an identifier acquiring unit 303 to acquire the identifier 101 from the stapler needle 3 using the RFID communicating unit 300, a control information retrieval unit 305 to obtain the control information 510 through communication with the system 1 to retrieve control information 510 corresponding to an input from the user, an identifier matching determining unit 304 to check the control information 510 to determine whether or not the control information 510 matches the identifier 101 obtained by the identifier acquiring unit 303, a notifying unit 309 to notify, if the control information 510 matches the identifier 101, the matching event, a light emission unit 312 to send notification to the user by light from a light emitting device, and a sounding unit 313 to send notification to the user by voice, sound, or vibration using a sounding device. The information terminal 5 further includes a secret presence or absence determining unit 307 to check the identifier 101 from the identifier acquiring unit 303 and the control information 510 to determine whether or not the pertinent information is secret information, a notification suppression emphasizing unit 308 having a function which changes, if the information is secret information, the notifying method of the notifying unit 309, an image file acquiring unit 314 to acquire, according to the control information 510 retrieved by the control information retrieval unit 305, an image file from the file creating and deleting unit 204 of the system 1, a decrypting unit 310 to decrypt, if the image file has been encrypted, the image file, and a display unit 311 to display an image file using a display of the information terminal 5.

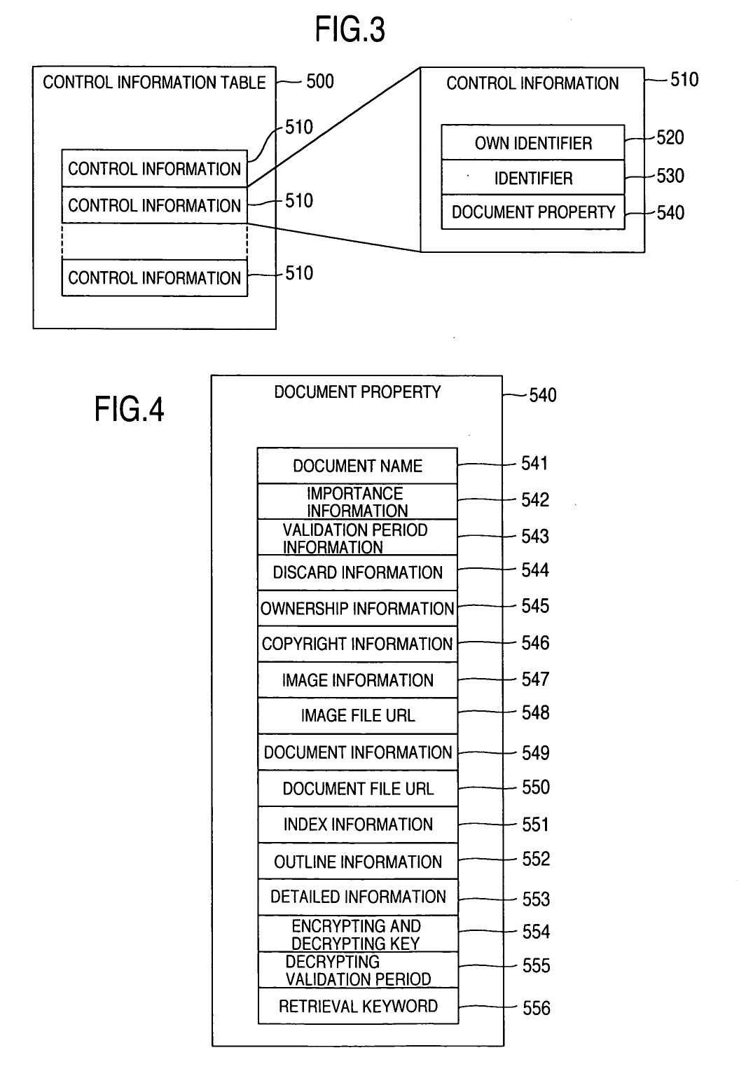

Referring next to FIG. 3, description will be given of the control information table 500 and the control information 510. The table 500 is a database including one or a plurality of control information entries or items 510. The control information managing and deleting unit 208 controls the table 500.

The control information 510 includes an own identifier 520 to uniquely identify the control information 510, an identifier 530 to be stored in the identifier 101 of the RFID 4, and document property 540 to store information of a document to be controlled. The control information 510 is information to relate the identifier 101 of the RFID 4 installed in the stapler needle 3 to the document property 540, that is, information indicating a document corresponding to the identifier 101.

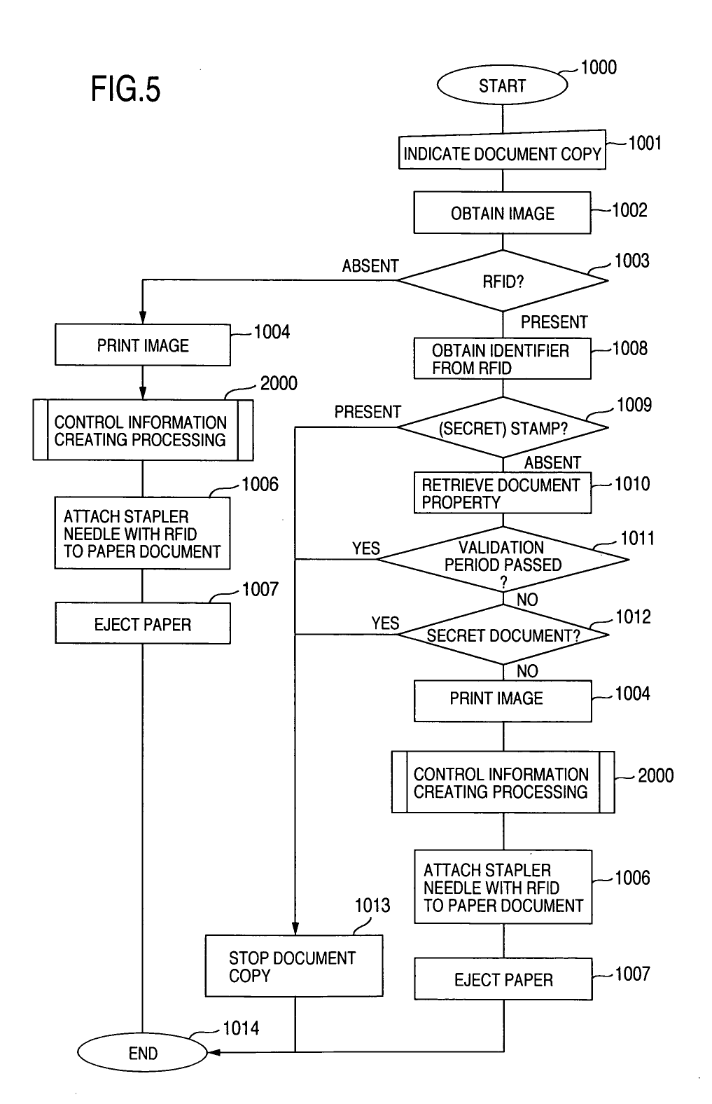

Referring now to FIG. 4, the document property 540 will be described.

The document property 540 includes a document name 541 indicating a name of a document, importance information 542 indicating whether or not the pertinent information is secret information, validation period information 543 indicating a period of validation, discard information 544 indicating whether or not the pertinent information may be discarded, ownership information 545 indicating ownership of a document, copyright information 546 indicating a copyright, image information 547 which is information obtained by representing a document as an image, and an image file Uniform Resource Locator (URL) 548 indicating a location on a network in which an associated document is stored. The document property 540 further includes document information 549 which is information obtained by representing the contents of the document in the form of texts, a document file URL 550 indicating a location on a network in which the document information 549 is stored, index information 551 indicating an index of the document, outline information 552 indicating an outline of the document, detailed information 553 indicating the document in detail, an encrypting and decrypting key 554 which is key information to decrypt the encrypted image or document information 547 or 549, a decrypting validity period 555 indicating a period of validity of the encrypting and decrypting key 554, and a retrieval keyword 556 which is text information to be used to retrieve the document. The document property 540 does not necessarily include all of the items. Specifically, the document property 540 essentially includes either one of the image information 547 and the image file URL 548; the importance information 542, the validity period information 543, the discard information 544, and the encrypting and decrypting key 554.

Next, referring to the flowchart shown in FIG. 5, description will be given of operation of the system 1, specifically operation to automatically relate, if a paper document is printed or copied, information of an RFID to information thus printed and operation to inhibit, if a document to be copied is a secret document or the validation date thereof has passed, copying of the document.

The user first activates the system 1 (1000). When a document copy indication is received from the user (1001), the system 1 acquires an image, i.e., a read image of a paper document by, for example, a scanner (1002). Simultaneously, to determine whether or not the stapler needle 3 with RFID has been attached to the paper document, the system 1 communicates with the RFID 4 (1003). If the RFID 4 is present, control goes to step 1008, which will be described later. Otherwise, the system 1 starts processing to attach a stapler needle with RFID. The system 1 first prints the image information obtained in step 1002 on a sheet of paper, i.e., an image is printed on the sheet of paper (1004).

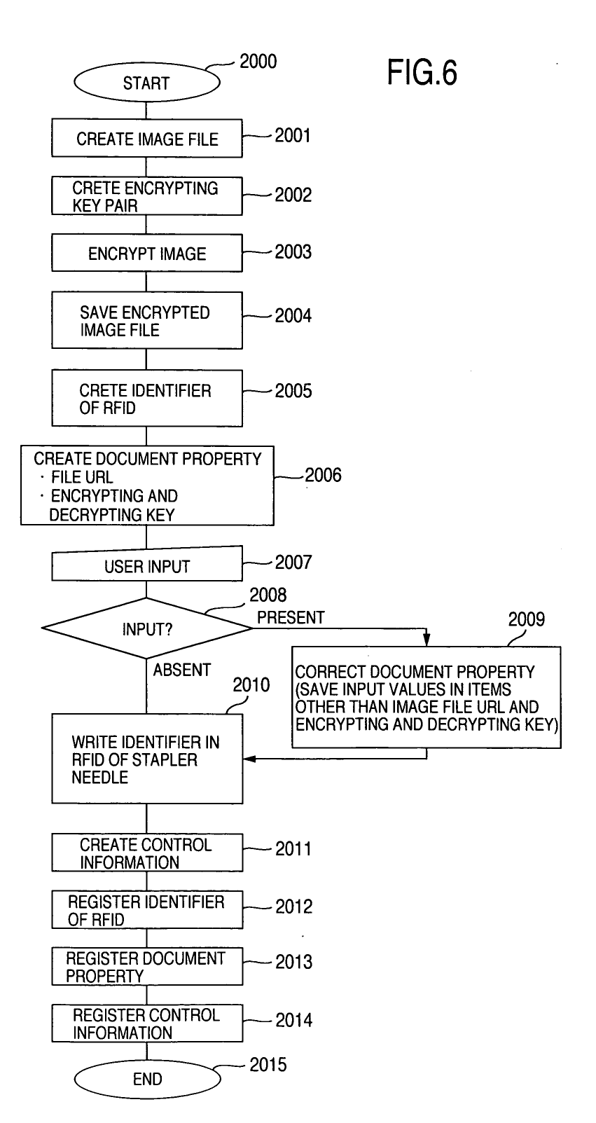

Next, the system 1 executes control information creation processing to create control information 510 corresponding to the paper document (2000). The processing 2000 will be described later in conjunction with FIG. 6. In the processing 2000, a stapler needle 3 with RFID is created. The needle 3 is attached to the printed sheet of paper (1600), and the sheet is ejected from the copying machine 1 (1007) to thereby terminate the processing (1014). If an RFID 4 is present in step 1003, the system 1 communicates with the RFID 4 to obtain an identifier 101 (1008). The system 1 then checks the image information obtained in step 1002 to execute image comparison processing (1009) to determine presence or absence of an icon or an image indicating that the pertinent information is secret information. If it is determined that such an icon or image is present, the system 1 inhibits the processing of printing the image information by a printer (1013) to thereby terminate the processing (1014).

If it is determined that such an icon or image is absent, the system 1 makes a search for the identifier 101 and the control information 510 stored in the control information table 500 to obtain the control information 510 matching the identifier 530 (1010). The system 1 next compares the validity period information 543 contained in the document property 410 of the control information 510 with the current day and time. If the validation period of the document has passed (1011), the system 1 terminates processing to copy the document (1013) to thereby terminate the processing (1014). Otherwise, the system 1 refers to the importance information 542 contained in the document property 410 of the control information 510 to determine whether or not the pertinent information is secret information (1012).

If the information is secret information, the system 1 stops processing of copying the document (1013) to thereby terminate the processing (1014). Otherwise, the system 1 prints the image information obtained in step 1002 on a sheet of paper to produce a printed image (1004). Next, the system 1 executes control information creation processing to create control information 510 corresponding to the paper document (2000). The processing 2000 will be described later in conjunction with FIG. 6. In the processing 2000, a stapler needle 3 with RFID is created. The needle 3 is attached to the printed sheet of paper (1006), and the sheet is ejected from the copying machine 1 (1007) to thereby terminate the processing (1014).

Through the operations of the functions, it is possible in the copying machine-server device-shredder apparatus 1 to implement an operation to automatically relate, when a paper document is printed or copied, information of an RFID to information thus printed and an operation to inhibit, when a document to be copied is a secret document or is a document of which the validity period is overdue, the copy of the document.

Next, referring to the flowchart shown in FIG. 6, description will be given of the control information creating processing 2000 to create the control information 530 and to create the stapler needle 3 with RFID.

First, the system 1 creates a file using the image information obtained in step 1002 to store the file in a storage device such as a hard disk or an optical disk of the server device 1 and then converts a file name thereof into an image file URL or a document file URL (2001). The system 1 then generates an encryption key pair to encrypt the image (2002). This is a known technique to conduct encryption and decryption by use of public key information and a secret or private key simultaneously generated in advance. The encryption key pair information is used to encrypt image information using a public key and to decrypt the encrypted image information using a private key.

Using the public key, the system 1 encrypts the image information saved in the storage device (2003) and stores the encrypted image information as an image file (2004). The system 1 then generates an identifier 101 to uniquely identify the RFID 4 (2005). The RFID 4 is written as an identifier 101 constituting the RFID 4 installed in the stapler needle 3. By communicating with the RFID 4, the system 1 can obtain information of the identifier 101 to resultantly uniquely identify the RFID 4.

The system 1 generates the document property 540 in a storage (2006). In the operation, the image or document file URL saved in step 2001 and the private key paired with the public key used in step 2003 are stored in the image file URL 548 or the document file URL 550 and the encrypting and decrypting key 554 of the document property 540 (2006).

The system 1 checks reception of a user input (2007), and if an input is present (2008), the system 1 corrects the document property 540 (2009). The correction is made for the items of the document property 540 excepting the image file URL 548, the document file URL 550, and the encrypting and decrypting key 554, that is, the document name 541, the importance information 542, the validation period information 543, the discard information 544, the ownership information 545, the copyright information 546, the image information 547, the document information 549, the index information 551, the outline information 552, the detailed information 553, the decrypting validity period 555, and the retrieval keyword 556. By setting these items, it is possible to determine afterward whether or not the document is a secret document, whether or not the validation period is overdue, and whether or not the document may be discarded. If it is determined in step 1009 that the information is secret information, the system 1 sets the importance information 542 as secret information. The system 1 writes the identifier created in step 2005, in the identifier 101 of the RFID 4 of the stapler needle 3 (2010). The system 1 then creates the control information 510 described in conjunction with FIG. 3 and registers an identifier 520 thereto for unique identification thereof (2011).

The system 1 registers the identifier 101 written in the RFID item 4 in step 2010 to the identifier 530 of the control information 510 (2010) and the document property 540 created in step 2006 to the document property 540 of the control information 510 (2014). The system 1 then registers the control information 510 as a last entry of the control information table 500 (2014) to thereby terminate a sequence of processing (2015).

As a result of the operations of the functions, it is possible to implement an operation in which the control information 530 is created and the stapler needle 3 with RFID is created.

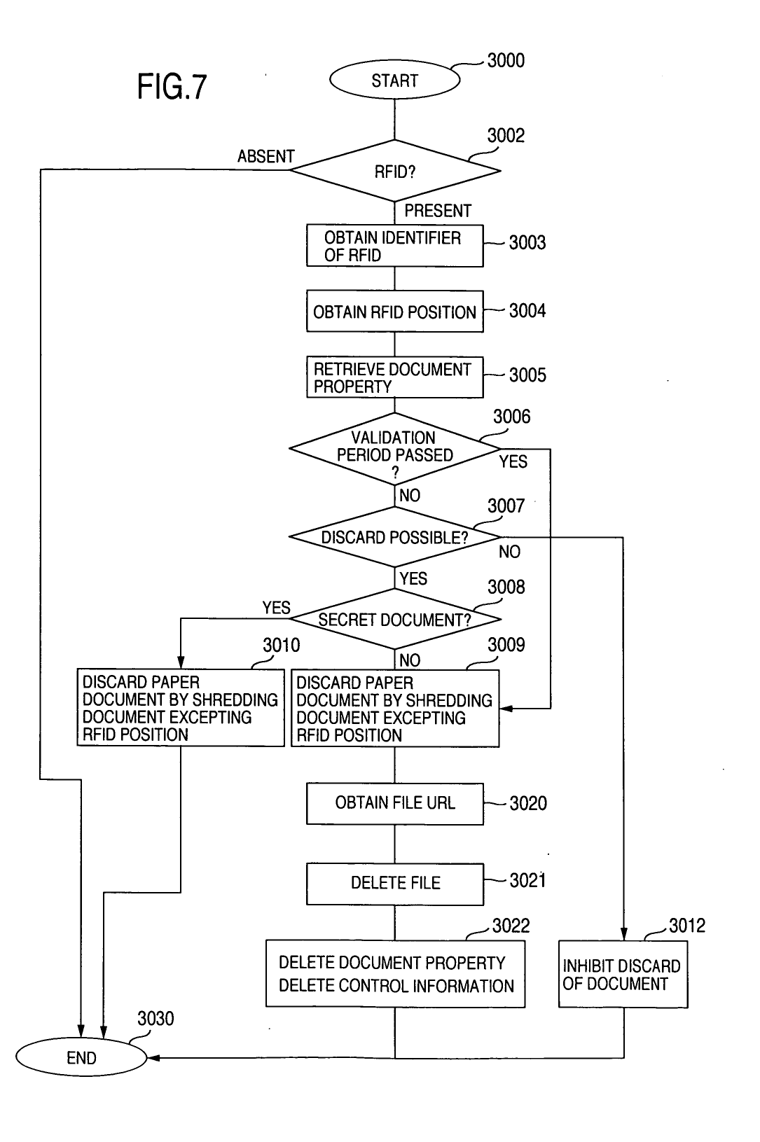

Referring now to the flowchart shown in FIG. 7, description will be given of operation of the embodiment, i.e., the copying machine-server device-shredder apparatus 1 in which a paper document printed or copied using an original document is shredded if the original document is a secrete document or if the validation period of the original document has passed.

Processing 3000 is activated immediately before the processing of step 1000 and subsequent steps in which the user inserts sheets of paper in the system 1 to conduct a copy operation. Alternatively, the processing is activated when the user instructs the shredder apparatus 1 to discard a document. First, the system 1 determines through communication whether or not an RFID 4 has been attached to the paper document 2 to be copied (3002). If such an RFID 4 is absent, the processing is terminated (3030) and control goes to step 1000 to execute the copy processing. If an RFID 4 is present, (3002), the system 1 obtains an identifier 101 from the RFID 4 (3003). The system 1 measures a position of the RFID 4 on the paper document (3004). This is achieved as below. That is provided by determining that the RFID 4 exists at a part corresponding to most sensitive position among a plurality of prepared radio wave sources.

Next, using the identifier 101 obtained in step 3003, the system 1 makes a search through the control information table 500 to obtain associated control information 510 and makes a search through the document property 540 (3005). The system 1 compares the validity period information 543 of the document property 540 with the current day and time (3006). If the validity period has passed, the system 1 executes step 3009. Otherwise, the system 1 checks the discard information 544 of the document property 540. If it is determined that the discard of the document is not allowed (3007), the system 1 terminates the processing (3030) without discarding the document (3012) and then executes the copy processing in step 1000.

If it is determined that the discard of the document is allowed, the system 1 checks the importance information 542 of the document property 540 to determine whether or not the information is secret information (3008). If the information is secret information, the system 1 shreds the paper document by a shredder apparatus to discard the paper document excepting the position of the RFID 3 obtained in step 3004 (3010) to thereby terminate the processing (3030). Otherwise, the system 1 shreds the paper document by the shredder apparatus to discard the paper document excepting the position of the RFID 3 obtained in step 3004 (3009) and then goes to step 3020. In step 3020, the system 1 obtains the image or document file URL 548 or 550 of the document property 540 (3020) to delete an image or document file kept in the file creating and deleting unit 204 of the server device 1 (3021). The system 1 discards the control information 510 of the document property 540 and deletes the control information 510 from the control information table 500 (3022) to thereby terminate the processing (3030).

As a result of the operations of the functions in the system 1, it is possible to accomplish an operation in which a paper document printed or copied using an original document is shredded if the original document is a secret document or if the validation period of the document has passed.

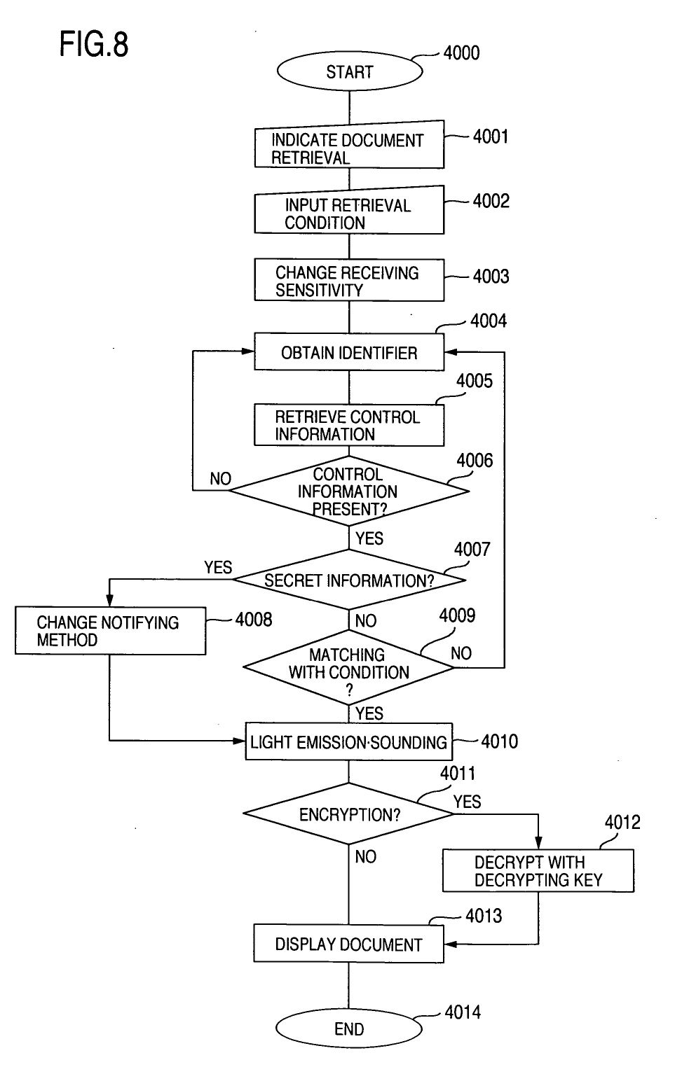

Next, referring to the flowchart shown in FIG. 8, description will be given of operation of the embodiment, i.e., the information terminal 5, specifically, operation to easily find out a paper document 2 bound by the stapler needle 3 and operation to change notifying representation when a secret document is detected.

The information terminal 5 is first activated (4000) to wait for an a document retrieval indication from the user (4001). If such an indication is issued, the terminal 5 receives, from an input device such as a keyboard of the user, information indicating a feature of the paper document 2 to be retrieved (4002). Simultaneously, also from the user, the terminal 5 obtains information indicating signal receiving sensitivity or distance for the retrieval of the paper document 2, sets a parameter of a communication unit of the terminal 5 to communicate with the RFID (4003), and then starts communication with the RFID.

If the communication with the paper document 2 is possible, the terminal 5 can acquire the identifier 101 of the RFID 4. Since the communication is not possible and the identifier cannot be obtained if the distance exceeds the predetermined distance for the communication, the terminal 5 continues communication with the RFID 4 (4004). When the identifier 101 is received, it is indicated that the terminal 5 is in the vicinity of a paper document 2 in which a stapler needle 3 with an RFID 4 is installed. The terminal 5 retrieves control information 510 according to the identifier 101 obtained in step 4004 and the control information table 500 of the system 1 connected thereto via a network (4005).

If the identifier 101 matches the identifier 530 of the control information 510, the process returns to step 4004 (4006). Since a plurality of identifiers 101 may also be obtained in step 4004, the retrieval is repeatedly carried out for all identifiers 101 thus obtained. If the control information 510 is detected in step 4006, the information terminal 5 checks the importance information 542 in the document property 540 of the control information 510 to determine whether or not the information is secret information (4007).

If the information is secret information, the terminal 5 changes the method of issuing notification to the user (4008) and proceeds to step 4010 (4009). The notification is achieved in step 4010 using light or sound. For secret information, the condition is notified to the user in a method in which, for example, the pattern of light emission is changed, the volume of sound is increased, or vibration or human voice is used (4010).

If the information is other than secret information in step 4007, the information terminal 5 makes a check to determine whether or not any information item of the retrieval condition received in step 4002 matches the associated information item of the document property 540 of the control information 510 (4009). If none of the items of the retrieval information matches the associated information item, the terminal 5 determines that the target document requested by the user does not exist in the system 1 and then returns to step 4004. If any one thereof matches the associated information item, the terminal 5 executes the light emission-sounding processing 4010 to notify the condition to the user.

If it is determined that the encrypting and decrypting key 554 has been set to the document property 540 and the encrypting validity period has not passed (4011), the terminal 5 decrypts the document or the image using the key 554 (4012) and displays the document or picture image on a display of the terminal 5 to thereby terminate the processing (4014).

Using the operations of the functions in the information terminal 5, it is possible to carry out an operation to find out the paper document 2 bound by the stapler needle 3 with the RFID 4 and an operation to change the notifying representation when a secret document is detected.

The present invention is effectively applicable to the document control system in a situation utilizing an electronic document on a network and a paper document.

It should be further understood by those skilled in the art that although the foregoing description has been made on embodiments of the invention, the invention is not limited thereto and various changes and modifications may be made without departing from the spirit of the invention and the scope of the appended claims.

1. A copying machine comprising control information and communicating with a stapler needle or a holder in which an RFID is installed, the control information including an identifier of the RFID and or validity period information or importance information indicating that associated information is secret information, comprising:
image information creating unit for obtaining an image of a paper document and thereby producing image information;
printing unit for printing the image information;
control unit for restricting copying of a paper document;
RFID communicating unit for communicating with the RFID; and
identifier obtaining unit for obtaining an identifier of the RFID, wherein
the copying of the paper document is restricted according to the validity period information or the importance information which indicates that associated information is secret information, the validity period information or the importance information being included in the control information corresponding to the identifier obtained by the identifier obtaining unit.

2. A copying machine comprising control information and connecting via communicating unit to a stapler needle or a holder in which an RFID is installed, the control information including an identifier of the RFID and validity period information or importance information indicating whether or not associated information is secret information, comprising:
image information obtaining unit for obtaining an image of a paper document;
image information creating unit for producing image information from the image;
printing unit for printing the image information;
control unit for restricting copying of a paper document;
RFID communicating unit for communicating with an RFID;
identifier obtaining unit for obtaining an identifier;
control information creating and deleting unit for creating, deleting, and keeping the control information; and
input and output unit including a function for implementing a user interface for a user and thereby editing the control information.

3. A copying machine according to claim 1, further comprising:
identifier creating and deleting unit for creating and deleting the identifier of the RFID; and
stapler attaching unit for attaching to a paper document a stapler needle or a holder including an RFID of which an identifier is created or deleted by the identifier creating and deleting unit.

4. A copying machine according to claim 1, further comprising validity period determining unit for retrieving the control information using the identifier of the RFID thus obtained, reading the validity period information corresponding to the identifier, and determining whether or not the paper document to be copied is within a validity period thereof, wherein
if the validity period determining unit determines that the validity period has passed, the control unit inhibits the copying of the paper document.

5. A copying machine according to claim 1, further comprising secret presence or absence determining unit for retrieving the control information using the identifier of the RFID thus obtained, reading the importance information corresponding to the identifier, and determining whether or not the paper document to be copied is a secret document, wherein
if the secret presence or absence determining unit determines that the paper document is a secret document, the control unit inhibits the copying of the paper document.

6. A copying machine according to claim 1, further comprising:
file creating and deleting unit for keeping, creating, and deleting the image information created by the image information creating unit; and
encrypting unit for encrypting the image information and saving the image information thus encrypted, the image information thus encrypted being saved as a file by the file creating and deleting unit.

7. A copying machine according to claim 6, wherein if the importance information indicates that the information is secret information or the validity period information indicates that the validity period has passed, the file saved by the encrypting unit is deleted.

8. A server device connected via a network to a copying machine comprising control information and communicating with a stapler needle or a holder in which an RFID is installed, wherein:
the control information of the copying machine includes an identifier of the RFID and validity period information or importance information indicating that associated information is secret information, and the copying machine can obtain an image of a paper document, produce image information, print the image information, and communicate with the RFID to obtain an identifier of the RFID to restrict printing of the paper document according to the validity period information or the importance information which indicates that associated information is secret information, the validity period information or the importance information being included in the control information corresponding to the identifier, the server device comprising:
file creating and deleting unit for keeping, creating, and deleting the image information created by the image information creating unit; and
encrypting unit for encrypting the image information and saving the image information thus encrypted, the image information thus encrypted being saved as a file by the file creating and deleting unit, the control information of the copying machine including URL information indicating a position on a network of the server device.

9. A sever device according to claim 8, wherein if the importance information indicates that the information is secret information or the validity period information indicates that the validity period has passed, the file saved in the server device is deleted.

10. A sever device according to claim 8, wherein:
the control information includes information designating whether or not image information can be discarded; and
if the information indicates that the image information can be discarded and if the importance information indicates that the information is secret information or the validity period information indicates that the validity period has passed, the file saved in the server device is deleted.

11. A copying machine comprising control information and communicating with a stapler needle or a holder in which an RFID is installed, the control information including an identifier of the RFID and validity period information or importance information indicating that associated information is secret information, comprising:
image information creating unit for obtaining an image of a paper document supplied thereto and thereby producing image information;
printing unit for printing the image information;
control unit for restricting copying of a paper document;
RFID communicating unit for communicating with the RFID; and
identifier obtaining unit for obtaining an identifier of the RFID,
the copying machine being capable of restricting copying of the paper document according to the validity period information or the importance information which indicates that associated information is secret information, the validity period information or the importance information being included in the control information corresponding to the identifier obtained by the identifier obtaining unit, the copying machine further comprising:
a shredder unit capable of shredding, by physical means, a paper document supplied thereto; and
paper document discarding unit for controlling the shredder unit,
the copying machine controlling physical shredding of the paper document by operating the paper document discarding unit according to the validity period information or the importance information which indicates that associated information is secret information.

12. A copying machine according to claim 11, wherein if the importance information indicates that the information is secret information or the validity period information indicates that the validity period has passed, the paper document discarding means is operated to discard the paper document by shredding the document.

13. A shredder apparatus for use with a copying machine comprising control information and communicating with a stapler needle or a holder in which an RFID is installed, wherein:
the control information of the copying machine includes an identifier of the RFID and validity period information or importance information indicating that associated information is secret information, and the copying machine can obtain an image of a paper document supplied thereto, produce image information, print the image information, and communicate with the RFID to obtain an identifier of the RFID to restrict copying of the paper document according to the validity period information or the importance information which indicates that associated information is secret information, the validity period information or the importance information being included in the control information corresponding to the identifier, the shredder apparatus comprising:
a shredder unit capable of shredding the paper document by physical means; and
paper document discarding unit for controlling the shredder unit, the shredder apparatus controlling physical shredding of the paper document by operating the paper document discarding unit according to the validity period information or the importance information which indicates that associated information is secret information.

14. A copying machine according to claim 11, further comprising stapler needle position acquiring unit for detecting a position of a stapler needle attached to the paper document, wherein the paper document discarding unit comprises:
a function to obtain a portion of the paper document excepting the position of the stapler needle; and
a function to shred the portion of the paper document, thereby avoiding damage of the shredder unit, the damage being caused by shredding the stapler needle.

15. A copying machine according to claim 4, further comprising stamp detecting unit for analyzing the image information obtained by the image information creating unit and obtaining an icon, a stamp, or an image indicating that the information is secret information, wherein
the copying machine inhibits the copying of the paper document if the stamp detecting unit detects the stamp and it is determined according to the control information that the validation period has passed.

16. A copying machine according to claim 4, further comprising stamp detecting unit for analyzing the image information obtained by the image information creating unit and obtaining an icon, a stamp, or an image indicating that the information is secret information, wherein
the copying machine inhibits the copying of the paper document if the stamp detecting unit detects the stamp and it is determined according to the control information that the information is secret information.

17. An information terminal for use with a copying machine comprising control information and communicating with a stapler needle or a holder in which an RFID is installed, wherein:
the control information of the copying machine includes an identifier of the RFID and information to control copying, and the copying machine can obtain an image of a paper document supplied thereto, produce image information, print the image information, and communicate with the RFID to obtain an identifier of the RFID to control copying of the paper document according to the information to control copying, the information being included in the control information, the information terminal comprising:
RFID communicating unit for communicating with the RFID;
identifier obtaining unit for obtaining an identifier of the RFID by communicating unit;
input unit for implementing a user interface for a user and thereby enabling an input of a user indication from the user;
control information retrieving unit for acquiring the control information corresponding to the user indication inputted from the input unit via the communicating unit from the copying machine; and
identifier matching determining unit for determining whether or not the identifier included in the control information matches the identifier obtained by the identifier obtaining unit,
the information terminal notifying the user, if the identifiers match each other, that the identifiers match each other.

18. An information terminal according to claim 17, further comprising:
distance measuring unit for measuring distance between the RFID and the information terminal; and
measurement distance changing unit for setting distance indicated by the input unit to the distance measuring unit.

19. An information terminal according to claim 17, wherein the information terminal refers to the control information according to the identifier obtained by the identifier obtaining unit and changes, if the information to control the copy of the paper document indicates that the associated information is secret information, a notifying method of notifying that the associated information is secret information.

20. A copy control method for use with a copying machine comprising control information and communicating with a stapler needle or a holder in which an RFID is installed, the control information including an identifier of the RFID and or validity period information or importance information indicating that associated information is secret information, the method comprising the steps of:
obtaining an image of a paper document and thereby producing image information;
printing the image information;
restricting copying of a paper document;
communicating with the RFID;
obtaining an identifier of the RFID; and
inhibiting the copying of the paper document if the importance information indicates that the information is secret information or if the validity period information indicates that a validity period of the paper document has passed, the importance information and the validity period information being included in the control information corresponding to the identifier thus obtained.
